(19) United States
(12) Patent Application Publication
(10) Pub. No.: US 2005/0179724 A1
(43) Pub. Date: Aug. 18, 2005

(54) Droplet deposition apparatus

(76) Inventors: Bryan David Salt, Hertfordshire (GB); Stephen Temple, Cambridge (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/500,781

(22) PCT Filed: Jan. 16, 2003
(86) PCT No.: PCT/GB03/00150

(30) Foreign Application Priority Data
Jan. 16, 2002 (GB) 0200924.9
Jan. 17, 2002 (GB) 0201018.9

(51) Int. Cl. B41J 2/145; B41J 2/15

(52) U.S. Cl. 347/40

(57) ABSTRACT

An inkjet printer has a print head unit with four parallel rows of nozzles each row being able to receive an ink of a different color. The length of each row is less than the length of the print head unit. A number of print head units may be aligned together to provide elongate arrays of nozzles. The nozzle spacing along the array is non-uniform in that the inter-nozzle spacing within the rows is less than the inter-row spacing between neighboring print head units. In operation each print head unit deposits a non-contiguous swath on the paper and then all the units are moved an equal distance and a further swath printed thereby interleaving the swaths. A method of supplying ink and an ink supply member are also provided.

The present invention relates to droplet deposition apparatus, their methods of manufacture and methods of operation and printers containing such apparatus.

The versatility of inkjet print heads have made them suitable for a number of today's markets and recently significant gains have been made in markets typically dominated by other printing techniques such as laser printers and screen printers.

Laser printers are still dominant in the high-end office market where they are capable of printing about 4-10 colour pages per minute and 20-30 pages per minute black Inkjet printers are already on sale that can print at a speed approaching 10 pages per minute colour and page wide array print heads are in development that are capable of printing 100 or more pages a minute full colour.

These page wide print heads may have upwards of 1000 nozzles and may be formed either as a plurality of like modules butted together end to end or as a single bar. Building the print head as a plurality of modules allows for modules to pre-tested and, if faulty, scrapped before assembly. However, as page wide arrays are generally static, the paper passing beneath the head, it is necessary that the spacing of the nozzles through which ink is ejected is uniform across the width of the head.

It is generally required that nozzles are arranged at as close a spacing as possible as it is well known that increasing dot density generally improves image quality. A nozzle spacing of greater than 90 dpi or, more preferably, 180 dpi is typically required for most high image quality applications. Achieving uniform dot spacing across the width of the head is difficult at the butt joints, a problem overcome by forming the page wide array as a single bar with no butt joints. However, forming such a single unit means that even if a single nozzle or pressure chamber is faulty the entire head may need to be scrapped.

A lower specification print head is proposed in U.S. Pat. No. 6,293,651. A single bar is provided upon which a plurality of distinct modules is mounted at a uniform spacing. Each module only prints a proportion of the substrate passing beneath in a scanning direction, the bar being indexed in a print head direction direction after every rotation of the drum. The print head is typically monochrome though a colour array is proposed where every nth module is the same colour (n is typically 4 for black (K), cyan (C), magenta (M) and yellow (Y)).

A continuous array following this principle is described In WO 98136910. Swaths of colour are printed in repeating bands and the head is indexed after each swath until the first laid swaths have been overlaid with the other colours. As is noted in the application the order in which the swaths are laid down has a material effect on the colour of the image i.e. CMYK is different to KYMC.

The present invention seeks to provide improved apparatus, methods and routines that address these and other problems.

Accordingly, the present invention consists in one aspect in droplet deposition apparatus for depositing droplets on a substrate and comprising an elongate printhead, the substrate being removable relative to the printhead in a substrate movement direction and the length of the printhead extending in a printhead direction orthogonal to the substrate movement direction, wherein the printhead comprises at least one print head unit, the or each print head unit comprising at least two parallel rows of nozzles extending in the printhead direction with the rows being spaced apart in the substrate movement direction; actuation means for effecting the selective ejection of droplets from respective nozzles and a droplet fluid supply arrangement disposed such that a different fluid may be supplied to each row of nozzles.

Advantageously, the actuation means for effecting the selective ejection of droplets from respective nozzles, comprises for each nozzle a pressure chamber in communication with the nozzle and in communication with the fluid supply arrangement.

The rows of pressure chambers are preferably arranged such that they may each be supplied with an ink of a different colour or property. Typically four rows are provided though other numbers such as 2,3,5 or 6, for example, may also be used without departing from the scope of the present invention. Additionally, not all the rows must have different ink as more than one row may eject the same ink.

In a single colour head it is preferable that the nozzles of the rows are interleaved thereby providing a high density image on the substrate. In a multicolour device it is preferred that the nozzles of the rows are in registration along a line orthogonal to the direction of row elongation such that a droplet of ejection fluid from a first row is overprinted with a droplet of ejection fluid from a second row and subsequent row.

Preferably, the pressure chambers corresponding with one row of nozzles are provided in a row of pressure chambers on a base, with the pressure chambers corresponding with each other row of nozzles being provided in a respective other row of pressure chambers on the same base.

Usefully, there are provided on the base, divider means to define around each row of chambers a fluid manifold region for use in the supply of fluid to the chambers of that row, the respective manifold regions being separate from each other, with ports defined in the base communicating with each fluid manifold region.

Suitably, the base is planar and the divider means comprises a apertured divider plate with said apertures defining the respective manifold regions.

Alternatively, the divider may be separate portions, walls or seals which may or may not form part of two different manifolds. The ink manifolds may be provided as inlet and outlet manifolds connected through the ejection chambers thereby allowing for circulation of ink. Preferably an ink port is provided through a base substrate that partially defines the ink manifolds to allow fluid to pass through an ink port or ports from and to supply chambers provided in an ink supply unit.

If the head unit and rows of ejection chambers are of a particular size it may be beneficial to locate two or more ink ports within said ink manifold chambers. It is desirable that similar numbers of these ports are situated on either side of the array to ensure an even ink flow.

It is preferable that each row of nozzles in the print head unit has the same length. It is also desirable that the rows have the same inter-nozzle spacing where the inter-nozzle spacing is the distance between adjacent nozzles in the same row of nozzles.

The pressure chambers are preferably elongate with the direction of elongation lying orthogonal to the length of the nozzle row.

This construction is appropriate to most inkjet ejection mechanisms including, but not exclusively, bubblejet, piezoelectric, electrostatic, MEMS or bimorphs. A particularly preferred actuator is a shear mode piezoelectric device as described in EP 0 277 703.

The pressure chambers preferably comprise at least one wall having piezoelectric material with electrodes disposed so as to be able to apply a field the piezoelectric wall. Preferably the wall will deflect by shear mode into the pressure chamber thereby ejecting a droplet from the nozzle.

Where more than two rows of pressure chambers are provided achieving electrical connection to the inner row or rows may be difficult as a straight connection is not possible due to the positioning of each of the rows. It has been proposed in the past that complex multilayer circuits may be provided with the tracks to the inner arrays being located under the tracks to the outer arrays. This can create problems due to the additional complexity with short-circuits and the like. Additionally a very high interconnect density is required along one edge of the print head unit.

In a preferred embodiment electrical connection to the inner rows of pressure chambers is achieved by diverting tracks around the edges of the outer rows i.e. the rows nearer the edges of the print head unit.

Connection pads are provided that extend along at least one edge of the print head unit in the print head direction direction. The pads connect to a drive circuit by well known means such as, for example, flip chip or wire bonding. The pads preferably extend a greater length than the length of the row of pressure chambers. The outer pads, at both ends, along the edge connected to tracks that affect the inner row of chambers and the inner pads along the edge connected to tracks that affect the outer row of chambers.

The pads along the edge should be appropriate in robustness and strength to provide electrical and mechanical connection to an external circuit containing driver chips.

Where four rows are provided it is desirable to electrically connect two rows to connectors at one edge of the substrate and two rows to connectors at the opposite edge of the substrate.

The tracks can be formed by any appropriate technique but preferably by an electroless method, depositing a conformal coating and subsequently defining the tracks by laser patterning. Alternative techniques, for example, are providing a patterned substrate, depositing material and subsequently lifting off the pattern.

In a preferred embodiment a plurality of print head units are arranged along the print head direction direction. Preferably each print head unit is substantially identical with the rows on the print head units combining to provide respective arrays of nozzles.

It is preferred that the rows on each of the head units are provided in the same order in that if a particular ink is required from the first row and a different ink is required from a second row of a particular unit then the first row of all the units eject the same ink and the second rows eject the different ink. Therefore, each array preferably ejects the same type of ejection fluid.

In the preferred embodiment it is desired that the nozzle spacing along the array is non-uniform. Preferably the inter-gap spacing between the end nozzle of one row in an array and the neighbouring end nozzle of a different row in said array is greater than the inter-nozzle spacing within either of the rows. Even more preferably the inter-gap spacing equals the row length plus twice the inter-nozzle spacing.

It is this relatively large inter row spacing in an array that allows for the electrical connection described above.

A layer of a polymeric material, such as parylene can be located on the surface of said head unit to provide protective aspects and additionally performance improvements.

An ink supply support may be provided that comprises a support having a top surface and a bottom surface, a printhead can be mounted directly or indirectly to said top surface, a plurality of walls extending from said bottom surface to define a plurality of partitioned rooms, and an insert provided between said partitions, said insert defining at least one chamber.

The ink supply support may be attached to the print head unit using a connector that uses solder, Woods metal or some other appropriate connector.

The insert can define the chamber completely or just provide a further partition within the rooms. Ports may be provided in the inserts that align with holes in the module substrate and holes provided in the top of the support.

Alternatively, plastic inserts containing supply fittings may be provided and laminated with partitions, the partitions being distinct A top surface thus formed onto which the print head unit may be mounted may be machined or lapped to form a flat surface. Other features may be moulded into the insert such as alignment features.

The insert is preferably plastic and may be coated with a layer of parylene, said layer of parylene extending through the holes provided in the top of the support to provide a seal. The parylene also traps dirt and prevents shedding of fibres from the plastic material and additionally prevents corrosive attack from certain types of ink.

In another aspect, the present invention consists in droplet deposition apparatus for depositing droplets on a substrate and comprising an elongate printhead, the substrate being movable relative to the printhead in a substrate movement direction and the length of the printhead extending in a printhead direction orthogonal to the substrate movement direction, wherein the printhead comprises at least one print head unit, the or each print head unit comprising a common base; at least two parallel rows of droplet liquid chambers provided on the base and extending in the printhead direction, each such chamber communicating with a droplet ejection nozzle so as to provide at least two parallel rows of nozzles extending in the printhead direction with the rows being spaced apart in the substrate movement direction; actuation means for applying pressure to each selected chamber to effect the ejection of droplets from respective nozzles and a droplet fluid supply arrangement disposed to supply a different fluid to each row of chambers.

In yet another aspect, the present invention consists in droplet deposition apparatus for depositing droplets on a substrate and comprising an elongate printhead, the substrate being movable relative to the printhead in a substrate movement direction and the length of the printhead extending in a printhead direction orthogonal to the substrate movement direction, wherein the printhead comprises a plurality of like print head units spaced along the length of the printhead, each print head unit comprising at least two parallel rows of nozzles extending in the printhead direction with the rows being spaced apart in the substrate movement direction; actuation means for effecting the selective ejection of droplets from respective nozzles and a droplet fluid supply arrangement disposed such that a different fluid may be supplied to each row of nozzles.

In a four row print head unit the ink flow within the support should preferably be arranged so that the very two outer supply cavities contain ink flowing from a row of pressure chambers. These two cavities are adjacent the driver chip and thus quickly remove heat Temperature differences to the ink inlets of each colour have a detrimental effect on the print quality and thus it is desirable to place the cavities containing the inlet of neighbouring arrays adjacent each other.

Thus, there is provided a method of supplying ink to a print head unit comprising the steps: providing a print head unit comprising at least two rows of nozzles extending along a print head substrate the length of each row lying in a print head direction direction, said rows lying parallel with the other rows in a direction orthogonal to said row length and wherein each row comprises an associated row of pressure chambers, providing an ink supply unit comprising supply manifolds and removal manifolds, disposing said ink supply unit and said print head unit in such a relation that each of said rows of pressure chambers communicates with a supply manifold and a removal manifold, said supply manifold and said removal manifold being adjacent, causing ejection fluid to flow from a supply manifold to a removal manifold through a pressure chamber in a flow direction; and wherein said flow direction for adjacent rows Of pressure chambers are opposite.

There is also provided a method of printing a multi-colour image comprising the steps: providing a printing apparatus as described above and supplying different colour ink to said rows of pressure chambers, ejecting a multi-colour swath from said print head unit, indexing said print head unit in said print head direction direction, and ejecting a further multi-colour swath from said print head unit.

The invention will now be described, by way of example only, with respect to the following drawings in which:

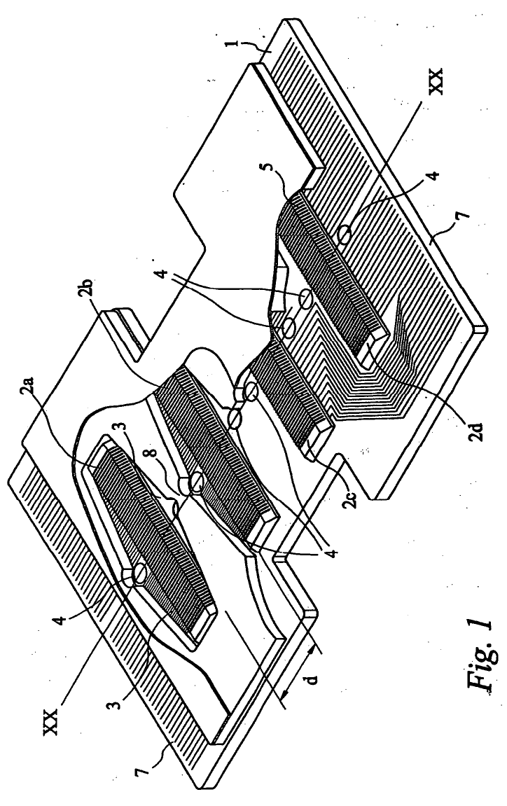

FIG. 1 is an exploded view of a printhead module/print head unit according to the present invention,

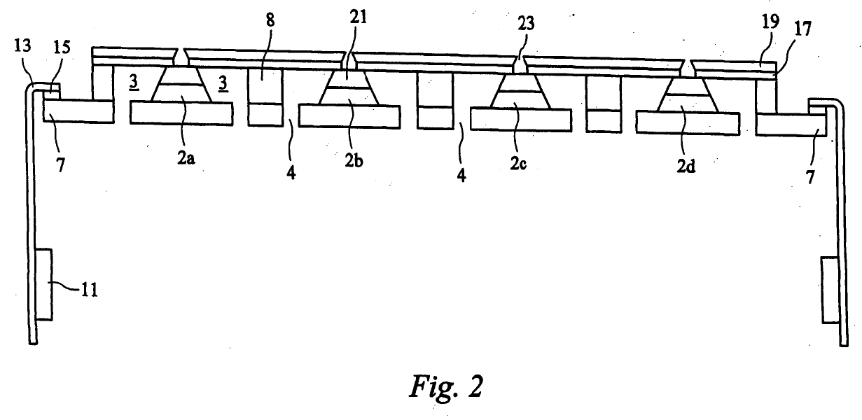

FIG. 2 is a cross-sectional view of the print head unit of FIG. 1 along line XX-XX with flexible circuit boards and associated chips attached.

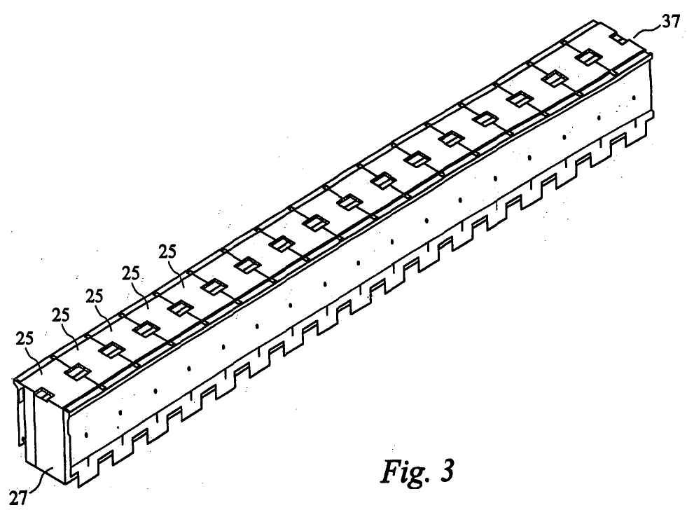

FIG. 3 is a wide printhead formed of a plurality of like print head units

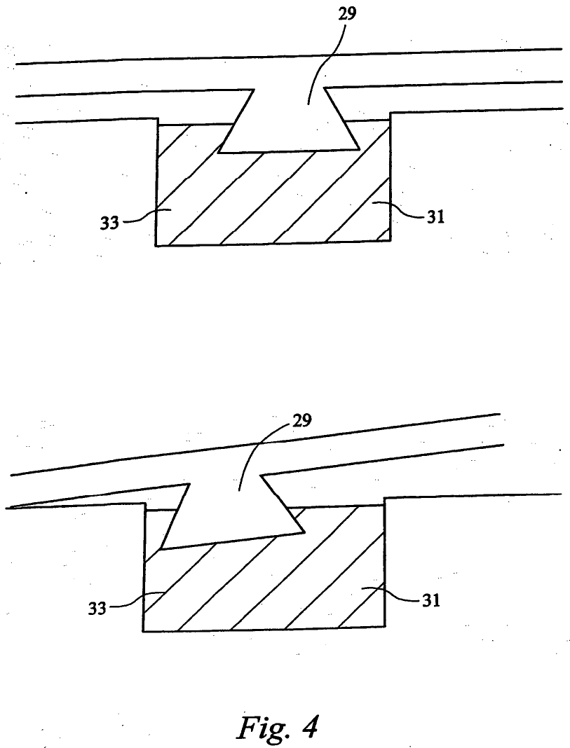

FIG. 4 depicts a method of attaching two components

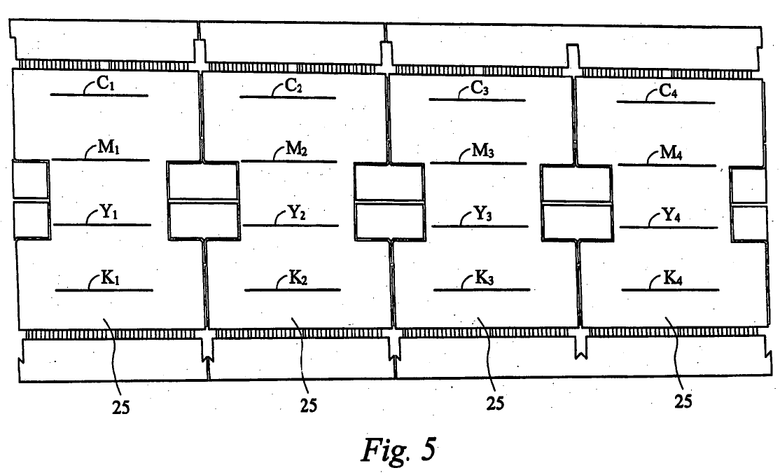

FIG. 5 depicts the colour configuration of said print head units—C, cyan, M, magenta, Y, yellow, K, black

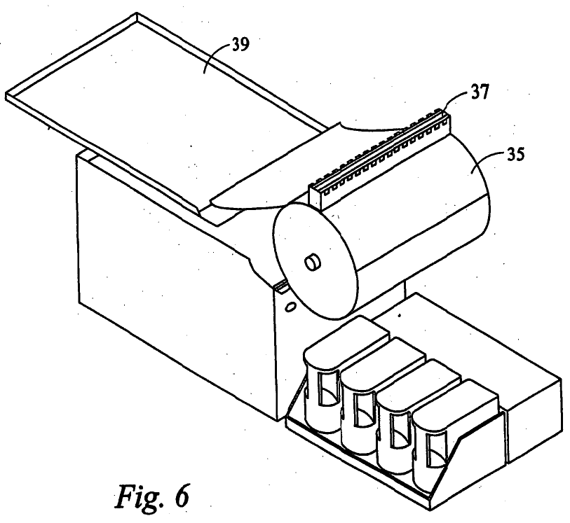

FIG. 6 depicts a printer configuration

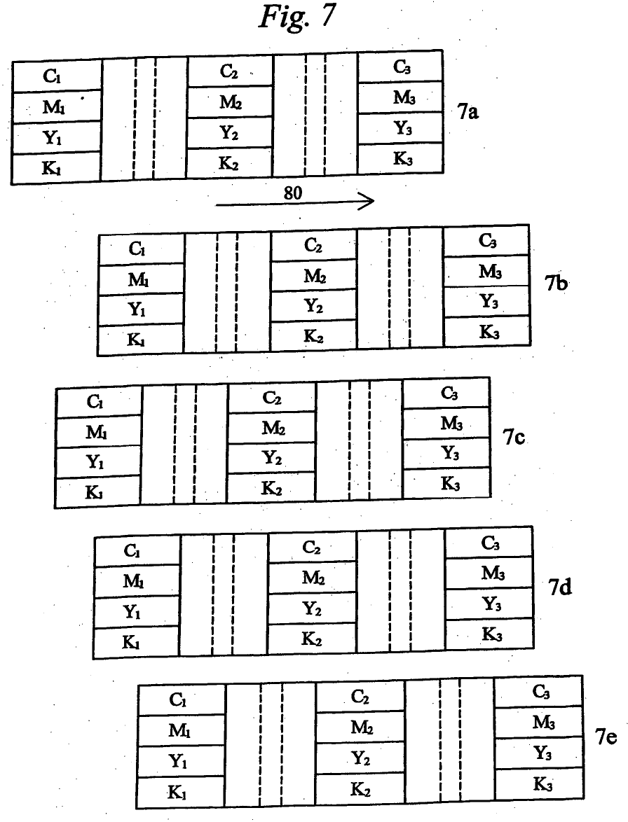

FIG. 7 depicts the printing routine

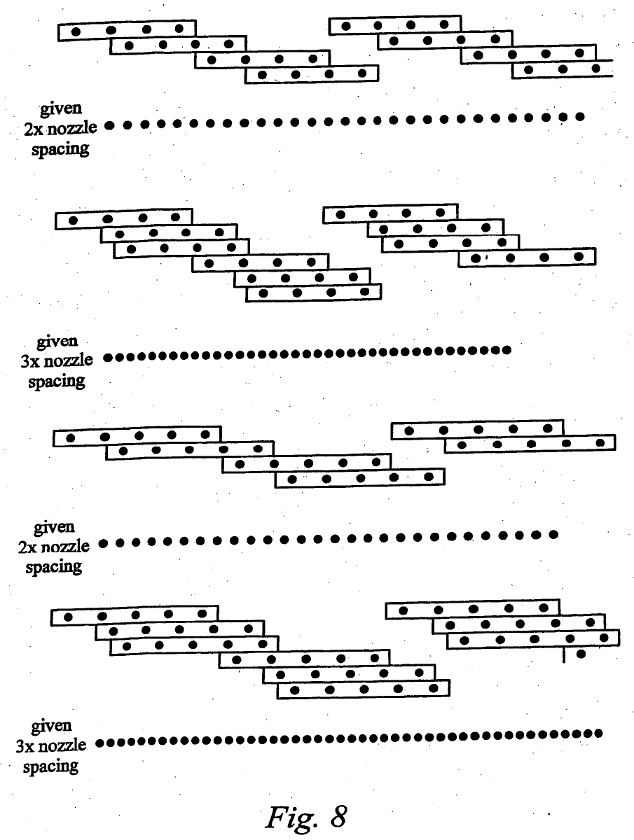

FIG. 8 depicts a further printing routine

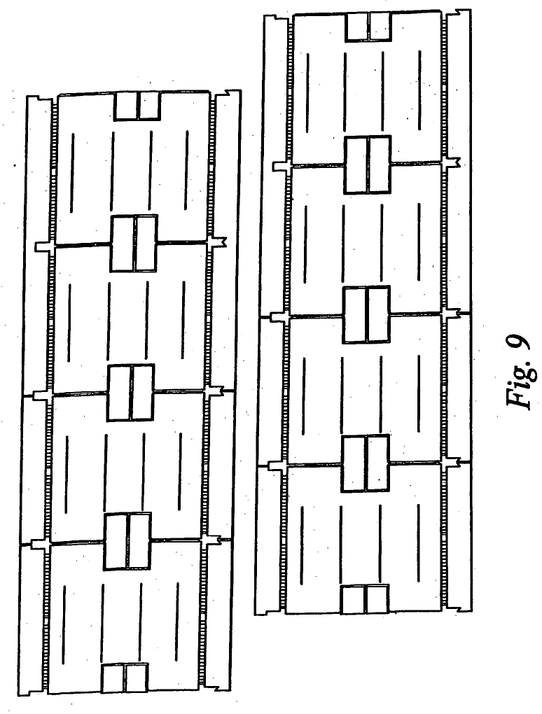

FIG. 9 depicts the printhead arrangement for a single pass printhead

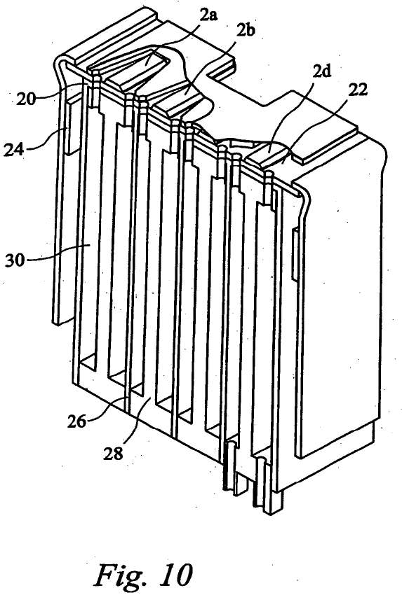

FIG. 10 depicts a supply support

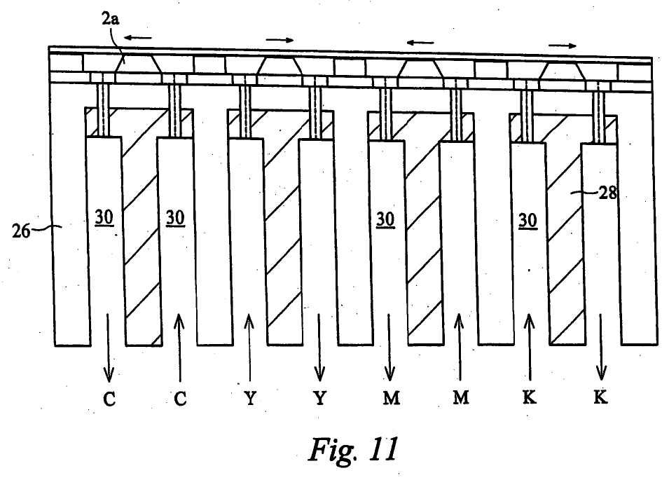

FIG. 11 shows the direction of ink flow within said support and printhead unit

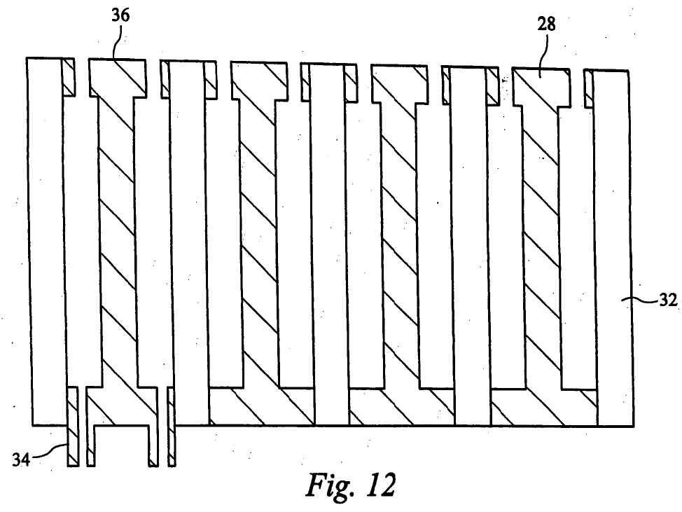

FIG. 12 depicts a supply support

With respect to FIG. 1, the print head unit is formed as a substantially “I” shaped base 1 which is provided with four strips 2a to 2d of piezoelectric material attached to the top surface and interspaced at an appropriate distance (d) in the substrate movement direction.

Channels 5, or pressure chambers, extending in the substrate movement direction are formed in the strips of piezoelectric material by sawing. Each of the pressure chambers is in registration with chambers formed in the other strips of piezoelectric material.

The piezoelectric material is lead zirconium titanate or PZT and the base is formed of a material having a similar thermal expansion characteristics to that of the PZT print head. The base must be robust enough to withstand the various manufacturing processes used in the manufacture of the print head unit Aluminium nitride, Alumina, INVAR or special glass AF45 are all examples of suitable candidate material.

Ports 4 are formed through the base at positions that fall within the inter-row spacing d. It is preferable that, in manufacture, the ports are formed prior to attaching the piezoelectric material 2a to 2d forming the strips though it is, of course, possible to drill them afterwards. Any suitable hole forming process is acceptable including ablation, drilling, etching etc.

Beneficially, formed onto the base are tracks for electrically connecting the PZT to driver chips located off the base. The manufacture of these tracks is described in greater detail in WO 00/29217 but will also be summarised here.

A conformal coating of electroless plating is deposited over the base and the sawn PZT. This coating is patterned to form both the tracks and the electrodes, said electrodes extending over the inner walls of the pressure chambers. A laser is directed at an angle perpendicular to the plane of the base to remove selected material from both the electrodes and the tracks thereby providing discrete connectors. The edges of the strips of piezoelectric material are chamfered to aid this process.

Appropriate electrode materials and deposition methods are well-known in the art. Copper, Nickel and Gold, used alone or in combination may be deposited advantageously by electroless processes and utilising a palladium catalyst will help provide the necessary intergity, adhesion to the piezoelectric material, resistance to corrosion and basis for subsequent passivation e.g. using silicon nitride or parylene as known in the art.

The electrodes on opposite sides of each actuator wall must be electrically isolated from one another in order that an electric field may be established between them and across the piezoelectric material of the actuator wall. The corresponding conductive tracks connecting each electrode with a respective voltage source must be similarly isolated.

The isolation is achieved after deposition by removing conducive material from those areas where it is not required. Localised vaporisation of material by laser beam. Material can also be removed from the entire top surface of the wall so as to maximise the wall top area available for bonding with the cover member or from a narrow band running over the top of the wall.

In addition to removing conductive material from the top surface of each piezoelectric actuator wall so as to separate the electrodes on either side of each wall, conductive material must also be removed from the surface of the substrate in such a way as to define respective conductive tracks for each electrode.

It will also be appreciated that the electrodes and conductive tracks associated with the active portions need to be isolated in order that the rows of nozzles might be operated independently. Although this too may be achieved by a laser “cut” along the surface of the substrate extending between the two piezoelectric strips, it is more simply achieved by the use of a physical mask during the electrode deposition process or by the use of electric discharge machining.

The conductive tracks defined by laser extends from the piezoelectric material to the connection pads arranged along the edge 7 of the substrate. Alternatively, the laser track definition process may be restricted to an area directly adjacent the piezoelectric material and a different—e.g. photolithographic—process used to define further conductive tracks that connect the laser-defined tracks with the integrated circuits.

Thereafter, both electrodes and tracks are passivated, e.g. using Silicon Nitride deposited in accordance with WO 95/07820. Not only does this provide protection against corrosion due to the combined effects of electric fields and the ink (It will be appreciated that all conductive material contained within the ink manifolds will be exposed to ink), it also prevents the electrodes on the opposite sides of each wall being short circuited by the planar cover member which will be described later.

Connection pads are provided along the top surface of the base adjacent the opposing edges arranged in the substrate movement direction. These may be formed in the same step as forming the tracks and electrodes or may be formed from an alternative technique such as bumping. The pads are used to electrically connect the tracks to a flexible circuit carrying driver and/or power chips. Preferably the pads also mechanically connect the base to the flexible circuit A flip chip or stud bump bonding technique are preferred with or without an adhesive.

The print head unit is a four colour, through flow print head and each strip of piezoelectric material is provided with two separate ports, one on either side of each strip. A divider plate 8 is provided that dissects the ports for adjacent strips to isolate and prevent colour mixing.

The base is sized and arranged such that the electric tracks to the inner trips of piezoelectric material originate from the pads arranged along the top surface of the base adjacent the opposing edges arranged in the substrate movement direction and follow a route around the ends of the outer strips of piezoelectric material.

Beneficially this allows for all four strips of piezoelectric material to be operated via two flexible circuits connected to the originating points or pads without resorting to complex multilayer wiring. Both the substrate and strips of piezoelectric material and the flexible circuits may be individually tested prior to combining in order to increase overall yield.

The divider is advantageously made of molybdenum or NILO 42 which, in addition to having similar thermal expansion characteristics to the alumina used elsewhere in the print head, can be easily machined, e.g. by etching, laser cutting or punching, to high accuracy.

The manifolds 3 defined by the divider plate 8 are shaped to reduce bubble traps and areas in which the fluid contained within is stagnant Where the length of the strip of piezoelectric material warrants multiple ports opening into the respective manifolds may be provided. The profile of the divider plate can be amended to reduce the likelihood of stagnant areas.

The divider plate is secured to the upper surface of the base by a layer of adhesive. In addition to its primary, securing function, this layer also provides back-up electrical isolation between the conductive tracks on the substrate and the divider plate where the divider plate is conductive. Registration features such as a notch may be used to ensure correct alignment with the base.

The last two members to be adhesively attached—either separately or following assembly to one another—are the planar cover member and nozzle plate. Optical means may be employed to ensure correct registration between the nozzles formed in the nozzle plate and the channels themselves. Alternatively, the nozzles can be formed once the nozzle plate is in situ as known, for example, from WO 93/15911.

A completed print head unit with complementary chips will now be described with reference to FIG. 2. The strips of PZT 2a to 2d are chamfered as described above to aid the track patterning. The interface between the ends of the channels and the ink manifold 3 provides an acoustic boundary. The walls of the channels are polarized such that when an electric field is applied across a wall between electrodes 21 located on the sides of the wall the wall deflects in shear into the channel.

The deflection initiates an acoustic wave within the chambers that is reflected at the acoustic boundary and converges at the nozzle to eject a droplet from the nozzle 23.

The cover plate 17 and nozzle plate 19 may be formed as a single component however, there is benefit in providing two separate components. The main benefit is that the adhesives attaching the nozzle plate to the cover plate and the cover plate to the divider plate and actuators may have different properties.

In particular, the adhesive attaching the nozzle plate to the cover plate is weaker than the adhesive attaching the cover plate to the divider plate. Beneficially, the nozzle plate may then be removed without removing the cover plate. This is of use, for example, when a nozzle is blocked or damaged in use or manufacture.

The cover plate can then be cleaned and prepared ready for a new nozzle plate to be attached. The piezoelectric material is relatively fragile and may be broken if the cover plate is removed too.

The chips 11 are mounted to the flexible circuit attached to the connection pads 15. Preferably these chips are orientated so as to be able to transfer a substantial amount of their heat to the ink supply system.

One additional manufacturing stage which may be performed either before or after forming the nozzles, but preferably before, is applying a conformal coating of parylene to the actuator. The coating is applied in the vapour phase and allowed to diffuse over and through the printhead unit. One advantage of parylene found by the applicant is that the size of the ports through which it diffuses have a limiting effect on the speed at which it is deposited and correspondingly the thickness of the layer formed.

Thus, due to the relative size of the channels to the ink supply ports, in a single step it becomes possible to passivate the actuator channels with a thin coating of passivant and the ink supply manifolds and ports with a thicker coating of passivant. Because the chamber is double ended the parylene diffuses along from both ends giving rise to a symmetrical coating. Similarly, as each strip of piezoelectric material is positioned within a substantially symmetrical manifold a uniform coating can be provided for each strip of channels and manifolds.

Beneficially, any particles of dirt or manufacturing debris remaining within the printhead can be bound to the walls under the layer of parylene thereby minimising the chance of nozzle blockage occuring once the head is filled with ink.

The benefits of a through flow ink supply and particularly where the ink flows continually through the pressure chambers even when printing is known, e.g. from WO 00/38928.

A plurality of print head units may be arranged side by side in a print head direction on an ink supply support 27 as depicted with reference to FIG. 3. Each print head unit is preferably substantially identical to the print head units and may be aligned or removed independently.

The print head units are shaped to allow for positioning in relation to a feature on the ink supply support. These alignment features may be static devices such as dowel pins and the like or active devices such as alignment screws. Other features to aid alignment may be provided on the print head unit itself.

One particularly elegant method of aligning and/or attaching the units is to use a low temperature solder, Woods metal or other appropriate material and is described with reference to FIGS. 4a-4b. Either the ink supply support or lower surface of the base is formed with a shaped projection and the opposing surface with a socket into which the projection is inserted. The shape of the socket 31 may be different to the projection 29.

The socket is filled with a low temperature solder, Woods metal or other appropriate material 33 that is kept the temperature at which it solidifies. The print head unit and ink supply unit may then be orientated with respect to each other in all three axis till the correct alignment is achieved. They are held in place whilst the solder, Woods metal or other appropriate material solidifies to both attach and secure the two components in the correct alignment.

By heating the solder or other material after attach it is possible to remove and replace the print head unit should it be found to be faulty.

The ink supply support comprises a plurality of cavities extending the length of the print head. Each of the ports in the base communicate with a cavity and thus ink is supplied to the print head. Other forms of the ink supply support will be described later.

Once the print head unit has been found to be working and is bonded to the ink supplying support parylene can be allowed to diffuse through the entire printhead structure. Beneficially the parylene can be used to seal any ink leaks within the system. Whilst parylene can diffuse through the system passively it is sometimes beneficial to force it through the system which is made possible by providing the double ended chambers.

The colour configuration of the array is as shown in FIG. 5, depicting the rows of nozzles C1, M1, Y1, K1, C2, M2 etc. for each of the print head units. The colours are arranged at the same position for each of the print head units. In the present embodiment, the pressure chambers are arranged at 180 dpi in each of the arrays.

The array along the print head does not have a uniform nozzle spacing. In particular, the inter-row spacing between the nozzle at the end of one row and the nozzle at the end of the row in the adjacent print head unit is greater than the spacing between the nozzles within the row.

A preferred operation of the printer will now be described with respect to FIG. 6. The print head 37 is mounted in a printer comprising a drum onto which paper is loaded. The drum 35 rotates beneath the print head 37 either once or more depending on the image to be printed. The paper or substrate 39 is held on the drum by a vacuum or some other mechanical means and as the drum rotates passes the print head in a substrate movement direction.

The print head structure proposed by the present invention is of particular use in a drum printing application due to its relatively compact structure in the substrate movement direction. Large distances between the rows in a print head unit lead to large errors in drop placement caused by differences in the distances the ejected drops must travel to reach the substrate. The curved surface of the drum providing this varied distance.

The print head structure of FIG. 3 will deposit a plurality of multi-coloured swaths on the substrate when the head is located in a fixed position in relation to the drum. Each swath may be printed in a single pass of the substrate or each colour may be printed separately to allow the deposited ink to dry between passes. The use of a drum allows the substrate to pass the print head a plurality of times.

In some circumstances this image will be acceptable, however, in the majority of cases it will be required to complete the image by filling the gaps between the adjacent swaths—the gaps being distance between the adjacent rows in neighbouring print head units.

In the preferred method, the entire print head is moved in the print head direction the distance of one nozzle row plus one inter-nozzle spacing after the multi-coloured swaths have been printed. A second set of multi-coloured swaths is then deposited to fill the area between the first set of multi-lour swaths. In this method it is of course necessary for the rows of adjacent print head units to be spaced apart in the print head direction a distance equal to the row length plus twice the inter-nozzle spacing.

FIG. 7a to 7d provides details of this and other print routines. Media is loaded onto the drum and held In place by a vacuum system or by grippers, preferably whilst the drum is already rotating at the printing speed. The printhead array, which extends substantially the width of the drum is positioned next to the drum and in a first pass of the paper on the drum all four colours are deposited at, in this case, 180 dpi as shown in FIG. 7a.

The paper then rotates on the drum once, or a plurality of times whilst the whole printhead is moved in the direction of arrow 80 without printing. In the simplest configuration, where the spacings between the individual rows along the printhead are equal to the length of the rows plus twice the nozzle spacing and printing is required at 180 dpi, the printhead can simply be moved the length of one row plus one nozzle spacing to fill in the unprinted areas left after the first pass as in FIG. 7b.

If a dot density is required that is twice that of nozzle pitch, the printhead can be moved in multiples of ½ nozzle pitch 7c to 7e which in combination with FIG. 7a provide an image at 360 dpi.

The array must have moved to a position a distance equal to its length from its staring point before printing the third swath 7d to avoid over-printing the earlier printed dots.

The paper is then removed from the surface of the drum and a new sheet applied. Beneficially the printhead does not have to be immediately moved back to its start position but can be moved in a direction opposite to arrow 80 whilst repeating the printing steps.

By changing the step length to, for example, ¼ of the array length plus % of a drop spacing it is possible to increase the dot spacing still further, in this case, to 720 dpi though a larger number of passes are required.

Since the entire head, being made up of a plurality of print head unit, moves by a distance less than twice the row lengths the difficulties associated with the acceleration and deceleration of large heads is not observed. This distance is typically below 5 cms and because the drum rotates at a constant speed accurate drop placement can be realised.

In some cases it may be beneficial to overlap printing from a first row with printing from a second row in the array. This may be achieved by, for example arranging the nozzles in the print head unit such that they are not in registration. Particular examples of these are shown in FIG. 8 for four and five nozzle arrays of a single colour. Without departing from the scope of the present invention described herein it is possible to operate colour arrays having many more nozzles.

The mathematics behind the routine can be calculated, without invention, by extrapolating the tenets described herein. This applies to rows arranged at a distance not equal to an row or swath width.

It is possible to provide a continuous array of ejected dots on a substrate by attaching a second print head, as shown in FIG. 9, to the printer mechanism with the rows of nozzles of the first print head interleaving with the rows of nozzles in the second print head. This of course adds to the cost of the printer and the array printed can only be at the original 180 dpi of the heads. Though by stepping the print heads it is possible to increase this drop spacing.

Turning now to the ink supply unit, a cut out of an ink supply according to the present invention is described with respect to FIG. 10.

A support 20 is formed either as an extrusion or as a cast module with aluminium or alumina being the preferred materials of manufacture. It is desirable that the material has a thermal expansion similar to that of the printhead unit 22 with a relatively high thermal transfer coefficient In order to transfer as much heat as possible from the driver chips 24 to the ink contained within the cavities 30.

The support supplies ink of four different colours to the rows of pressure chambers 2a to 2d and thus four cavities are provided and defined between the partitions 26. Preferably all the partitions are formed in the extrusion or casting step. In order to provide both an inlet and outlet manifold to supply and remove the circulating ink, a plastic insert 28 is positioned between the partitions.

The insert is described in greater detail with reference to FIG. 11. It defines two cavities either on its own or in conjunction with the partitions themselves. Where the insert defines the ink supply cavities on its own it is preferred that the walls are of a differing thickness with the outer walls of each insert being thinner than the inner wall dividing the cavities.

This structure allows a good heat transfer from the chip to the ink across the conductive exterior partition whilst minimising heat transfer between the inlet and outlet chamber separated by the insulating plastic partition.

It is known that the temperature of the fluid in a pressure chamber, has an affect on the volume of the drops ejected. It has also been found by the applicants that the heat contained within an outlet cavity can be transferred to an inlet cavity thereby increasing the overall temperature of the head and creating significant variations in ejection properties. In a compact print head unit like the one in the present invention the number of thermal boundaries between inlet and outlet cavities should be kept to a minimum. This is achieved by ensuring that neighbouring cavities supplying or removing ink from adjacent rows of pressure chambers in a print head unit have the fluid flowing in the same direction.

Thus, for a four row print head unit the minimum number of thermal boundaries is achieved by the following order

| Thermal Boudary | |
|---|---|
| Number 1 | Colour 1 Inlet and Colour 1 outlet |
| Number 2 | Colour 2 Inlet and Colour 2 outlet |
| Number 3 | Colour 3 Inlet and Colour 3 outlet |
| Number 4 | Colour 4 Inlet and Colour 4 outlet |

These thermal boundaries are additionally over the insulated walls of the plastic insert which lowers thermal transfer further.

Changing the direction of flow for even one row of the print head unit e.g. Row 1 (2a) we get the following:

| Themal Boundary | |
|---|---|
| Number 1 | Colour 1 inlet and Colour 1 outlet |
| Number 2 | Colour 1 outlet and Colour 2 inlet |
| Number 3 | Colour 2 inlet and Colour 2 outlet |
| Number 4 | Colour 3 inlet and Colour 3 outlet |
| Number 5 | Colour 4 inlet and Colour 4 outlet |

Additionally the second thermal boundary is over a non-insulated wall of the ink supply which further increases thermal transfer.

In a four row print head unit it is desirable if the outer cavities are outlet cavities as heat from the driver chips is absorbed to fluid leaving the print head.

Ink is preferably supplied to and from the cavities through the base rather than from the end of the support. Beneficially this allows for simpler and more elegant connection possibilities in the wider head configuration described below and a reduced pressure drop. Any fitting may be possible in the present invention including quick fit and screw type connectors and may be moulded into the insert. The positioning of the ink supply points along the printhead can be determined by routine experimentation.

To allow fluid to pass from the cavities to the pressure chambers holes are provided in the plastic insert that align with ports formed in the top of the ink supply support and the ports in the base of the print head unit Beneficially a coating of parylene can be applied to coat the inlet and outlet cavities and ports to provide a fluid tight, leak free seal.

The length of the ink supply unit may be extended such that a plurality of print head units can be attached to it. Alternatively, where an elongate print head is required each print head unit may comprise its own, isolated, ink supply unit.

In this structure of the ink supply unit the partitions may be cast as a single homogenous unit with a plurality of the plastic inserts either the length of a print head unit or multiple print head units provided therein.

The choice of plastics material forming the insert, whilst important, is widened through use of the construction above. Problems caused by thermal expansion mismatches are reduced by locating the insert within a fairly rigid structure and shedding of particles and ink incompatibilities, particular problems with some kinds of plastics are effectively eliminated by coating the inner surface of the cavities with parylene.

An alternative method of construction and support apparatus will be described with reference to FIG. 12. The plastic inserts 28, preferably containing supply fittings 34 are laminated with partitions 32. The top surface 36 onto which the print head unit is mounted can then be machined or lapped to form a flat surface.

Where the separate inserts are provided the ease of ink supply is not compromised as all the connection points are located on the opposite face of the printhead to the ejection nozzles. Similarly it is apparent that the electrical connection points are also located remote from the nozzles. This arrangement results in a simple and easily replaceable printhead.

Whilst the above invention has been described with respect to piezoelectric actuators it is equally possible to substitute the invention with other deposition devices including, but not exclusively, bubble jet or other mechanically actuated drop on demand printers.

The invention has been described by way of example only and a wide variety of modifications are possible without departing from the scope of the invention.

Each feature disclosed in this specification (which term includes the claims) and/or shown in the drawings may be incorporated in the invention independently of other disclosed and/or illustrated features.

1. Droplet deposition apparatus for depositing droplets on a substrate and comprising an elongate printhead, the substrate being movable relative to the printhead in a substrate movement direction and the length of the printhead extending in a printhead direction orthogonal to the substrate movement direction, wherein the printhead comprises at least two print head units spaced in the printhead direction, each print head unit comprising at least two parallel rows of nozzles extending in the printhead direction with the rows being spaced apart in the substrate movement direction; an actuator for effecting the selective ejection of droplets from respective nozzles and a droplet fluid supply arrangement disposed such that a different fluid may be supplied to each row of nozzles, wherein said units are arranged such that a nozzle row of one unit combines with a nozzle row from a different unit to form an array wherein the nozzles within an array are supplied with the same ejection fluid and wherein the gap spacing between the end nozzle of one row in an array and the neighboring end nozzle of a different row in said array is greater than the inter-nozzle spacing within either of the rows.

2. Apparatus according to claim 1, wherein each printhead unit comprises at least three rows of nozzles, with each row of nozzles receiving from the supply arrangement a different color of ink.

3. Apparatus according to claim 1, wherein each nozzle in one row of nozzles is aligned in position in the printhead direction with a nozzle in each of the other rows of nozzles.

4. Apparatus according to claim 1, wherein each row of nozzles has the same length.

5. (canceled)

6. Apparatus according to claim 1, wherein the actuator for effecting the selective ejection of droplets from respective nozzles, comprises for each nozzle a pressure chamber in communication with the nozzle and in communication with the fluid supply arrangement.

7. (canceled)

8. Apparatus according to claim 6, wherein said pressure chambers comprise at least one wall of piezoelectric material.

9. (canceled)

10. (canceled)

11. Apparatus according to claim 6, wherein the pressure chambers corresponding with one row of nozzles are provided in a row of pressure chambers on a base, with the pressure chambers corresponding with each other row of nozzles being provided in a respective other row of pressure chambers on the same base.

12. Apparatus according to claim 11, wherein there are provided on the base, a divider to define around each row of chambers a fluid manifold region for use in the supply of fluid to the chambers of that row, the respective manifold regions being separate from each other.

13. Apparatus according to claim 12, wherein ports are defined in the base for communication with each fluid manifold region.

14. Apparatus according to claim 13, wherein at least two ports communicate with each manifold region to proved a flow through each chamber.

15. Apparatus according to claim 11, wherein the base is planar and the divider comprises an apertured divider plate with said apertures defining the respective manifold regions.

16. (canceled)

17. (canceled)

18. (canceled)

19. Apparatus according to claim 1, wherein said array is linear.

20. (canceled)

21. (canceled)

22. Apparatus according to claim 1, wherein said gap spacing equals the row length plus twice the inter-nozzle spacing.

23. Apparatus according to claim 1 further comprising a transporter for supplying a printable substrate to a print zone disposed to receive droplets ejected from said nozzles.

24. Apparatus according to claim 23, wherein a paper transporter supplies said printable substrate to said print zone in said substrate movement direction.

25. Apparatus according to claim 23, wherein said paper transporter comprises a paper handling drum.

26. (canceled)

27. (canceled)

28. (canceled)

29. (canceled)

30. (canceled)

31. (canceled)

32. (canceled)

33. (canceled)

34. (canceled)

35. (canceled)

36. Droplet deposition apparatus for depositing droplets on a substrate and comprising an elongate printhead, the substrate being movable relative to the printhead in a substrate movement direction and the length of the printhead extending in a printhead direction orthogonal to the substrate movement direction, wherein the printhead comprises a plurality of like print head units spaced along the length of the printhead, each print head unit comprising at least two parallel rows of nozzles extending in the printhead direction with the rows being spaced apart in the substrate movement direction; an actuator for effecting the selective ejection of droplets from respective nozzles and a droplet fluid supply arrangement disposed such that a different fluid may be supplied to each row of nozzles and wherein the print head is movable relative to the substrate in the printhead direction to enable the nozzles of any row of nozzles to deposit droplets over a region of substrate broader than the length of the nozzle row.

37. (canceled)

38. Apparatus according to claim 36, wherein each printhead unit comprises at least three rows of nozzles, with each row of nozzles receiving from the supply arrangement a different color of ink.

39. (canceled)

40. Apparatus according to claim 36, wherein the actuator for effecting the selective ejection of droplets from respective nozzles, comprises for each nozzle a pressure chamber in communication with the nozzle and in communication with the fluid supply arrangement.

41. (canceled)

42. Apparatus according to claim 40, wherein said pressure chambers comprise at least one wall of piezoelectric material.

43. (canceled)

44. (canceled)

45. Apparatus according to claim 36, wherein said units are arranged such that the nozzle row on one unit combines with a nozzle row from a different unit to form an array wherein the nozzles within an array are supplied with the same ejection fluid.

46. Apparatus according to claim 45, wherein said array is linear.

47. Apparatus according to claim 45, wherein said arrays are disposed such that nozzle spacing along array is non-uniform.

48. Apparatus according to claim 45, wherein the gap spacing between the end nozzle of one row in an array and the neighboring end nozzle of a different row in said array is greater than the inter-nozzle spacing within either of the rows.

49. Apparatus according to claim 48, wherein said inter-gap spacing equals the row length plus twice the inter-nozzle spacing.

50. Apparatus according to claim 36, wherein the droplet fluid supply arrangement for each printhead comprises for each row of nozzles at least one fluid manifold.

51. Apparatus according to claim 50, wherein said ink manifold supplies ejection fluid to a pressure chamber associated with each nozzle, for flow of the ejection fluid through said pressure chamber to a further ink manifold associated with each row of nozzles.

52. (canceled)

53. Apparatus according to claim 50, wherein a port is provided that extends between an ink manifold and an ink supply chamber.

54. Apparatus according to claim 53, wherein said ink supply chamber is located within an ink supply unit.

55. Apparatus according to claim 1, wherein said or head units are mounted to an ink supply unit.

56. (canceled)

57. Apparatus according to claim 54, wherein said ink supply unit comprises a plurality of ink supply cavities at least one ink supply cavity communicating with a respective row of nozzles.

58. Apparatus according to claim 57, wherein a supply cavity is provided for each type of ejection fluid.

59. Apparatus according to claim 58, wherein said supply cavity is divided into an inlet supply cavity and an outlet supply cavity.

60. Apparatus according to claim 17, wherein said ink supply unit comprises a plurality of supply cavities each communicating with a respective array.

61. A method of supplying ink to a print head unit comprising the steps: providing a print head unit comprising at least two rows of nozzles extending along a print head substrate the length of each row lying in a print head direction, said rows lying parallel with the other rows in a direction orthogonal to said row length and wherein each row comprises an associated row of pressure chambers, providing an ink supply unit comprising supply manifolds and removal manifolds, disposing said ink supply unit and said print head unit in such a relation that each of said rows of pressure chambers communicates with a supply manifold and a removal manifold, said supply manifold and said removal manifold being adjacent, causing ejection fluid to flow from a supply manifold to a removal manifold through a pressure chamber in a flow direction; and
wherein said flow direction for adjacent rows of pressure chambers are opposite.

62. A method according to claim 61, wherein said print head unit comprises at least three rows of nozzles.

63. A method of printing a multicolor image on a substrate comprising the steps: providing a printing apparatus comprising an elongate printhead, the substrate being movable relative to the printhead in a substrate movement direction and the length of the printhead extending in a printhead direction orthogonal to the substrate movement direction, wherein the printhead comprises at least one print head unit, the or each print head unit comprising at least two parallel rows of nozzles extending in the printhead direction with the rows being spaced apart in the substrate movement direction; an actuator for effecting the selective ejection of droplets from respective nozzles and a droplet fluid supply arrangement disposed such that a different fluid may be supplied to each row of nozzles; supplying different colour color ink to said rows of pressure chambers, ejecting a multi-color swath from said print head unit, indexing said print head unit in said print head direction, and ejecting a further multi-color swath from said print head unit.

64. A method of printing a multicolor image on a substrate comprising the steps: providing a printing apparatus comprising an elongate printhead, the substrate being movable relative to the printhead in a substrate movement direction and the length of the printhead extending in a printhead direction orthogonal to the substrate movement direction, wherein the printhead comprises at least two print head units spaced in the printhead direction, each print head unit comprising at least two parallel rows of nozzles extending in the printhead direction with the rows being spaced apart in the substrate movement direction; an actuator for effecting the selective ejection of droplets from respective nozzles and a droplet fluid supply arrangement disposed such that a different fluid may be supplied to each row of nozzles; supplying different color ink to said rows of pressure chambers, ejecting a multi-color swath from said print head unit, indexing said print head unit in said print head, and ejecting a further multi-color swath from said print head unit.

65. A method according to claim 64, wherein a complete image is printed with one said indexing step.

66. A method according to claim 64, wherein said indexing step comprises indexing said print head n times a distance which is equal to 1/n times the sum of the nozzle row length plus the nozzle spacing.

67. Apparatus according to claim 1, wherein each printhead unit comprises four rows of nozzles, with each row of nozzles receiving from the supply arrangement a different color of ink.

68. Apparatus according to claim 36, wherein each printhead unit comprises four rows of nozzles, with each row of nozzles receiving from the supply arrangement a different color of ink.
